(19) United States
(12) Patent Application Publication
(10) Pub. No.: US 2010/0115597 A1
(43) Pub. Date: May 6, 2010

(54) COMPUTER READABLE MEDIUM, IMAGE PROCESSING SYSTEM, AND IMAGE PROCESSING DEVICE

(75) Inventor: Akira MURAKAWA, Toyonaka-shi (JP)

Correspondence Address: BUCHANAN, INGERSOLL & ROONEY PC, POST OFFICE BOX 1404, ALEXANDRIA, VA, 22313-1404, US

(73) Assignee: Konica Minolta Business Technologies, Inc., Chiyoda-ku (JP)

(21) Appl. No.: 12/606,491

(22) Filed: Oct. 27, 2009

(30) Foreign Application Priority Data
Nov. 5, 2008 (JP) 2008-284318

(51) Int. Cl. H04L 9/32

(52) U.S. Cl. 726/7; 726/19

(57) ABSTRACT

The present invention is intended to optimize reference data to be used in biometric authentication, and to reduce the incidence of false authentication in actual biometric authentication compared to conventional biometric authentication. In order to achieve this, a computer readable medium on which a program causing said computer to operate as a system is stored comprising: a biometric information acquisition part 51 for acquiring N pieces of biometric information by causing a biometric information reader 9a to read biometric information N times; a reference data selection part 52 for selecting one piece of biometric information from the N pieces of biometric information acquired by the biometric information acquisition part 51, and for provisionally setting the selected biometric information as reference data BD; an authentication test execution part 53 for acquiring authentication-testing biometric information by causing the biometric information reader 9a to read biometric information once, and for executing an authentication test by checking the authentication-testing biometric information against the reference data BD; and a reference data optimization part 54 for selecting one piece of biometric information from (N+1) pieces of biometric information including the N pieces of biometric information and the authentication-testing biometric information, thereby optimizing the reference data BD.

This application is based on the application No. 2008-284318 filed in Japan, the contents of which are hereby incorporated by reference.

### BACKGROUND OF THE INVENTION

1. Field of the Invention

The present invention relates to a technique of registering reference data on the basis of which authentication is executed in the biometric authentication technology using biometric information. The present invention more specifically relates to a computer readable medium, and an image processing system and an image processing device with a biometric authentication function.

2. Description of the Background Art

Image processing devices called as complex devices or MFPs (multifunction peripherals) include such a device that executes user authentication when used by a user. The user authentication in the image processing device is intended to raise the security level of the device itself, to limit users who are authorized to use a costly function such as color copy, or to achieve other objects. So, when a user performs an operation for authentication and is successfully authenticated, the user is put in the state of being logged into the image processing device. As a result, the user is allowed to use a function for which the user has been authorized in advance.

In order to execute user authentication with a higher security level, an image processing device executing biometric authentication by reading biometric information such as the fingerprint or the finger vein pattern of a user is recently coming into widespread use. According to the biometric authentication technology of this type, biometric information applied as reference data to be used in user authentication is registered in advance. Then, biometric information read from a user's living body is checked against the reference data in the user authentication, thereby authenticating the user.

In order to register reference data to be used in biometric authentication, biometric information is read several times, optimum biometric information is selected from the several pieces of biometric information, and the selected optimum biometric information is registered as reference data. This known technique is introduced for example in Japanese Patent Application Laid-Open No. 2007-648. In this technique, if a finger is held over a biometric information reader without changing its posture, several readings do not achieve any effect. As a result, appropriate reference data cannot be registered. In response, according to the disclosure of Japanese Patent Application Laid-Open No. 2007-648, it is determined whether or not a user's finger has taken off the biometric information reader after each reading when biometric information is read several times. If the user's finger is not taken off the biometric information reader, the user is prompted to take the finger off the biometric information reader.

In the biometric authentication technology described above, authentication of a user may end in failure even when the user is a rightful user whose reference data is registered. In order to avoid this false authentication, more appropriate biometric information should be selected for registering reference data. Like in the above-described conventional technique, biometric information is read several times, optimum biometric information is selected from the several pieces of biometric information, and the selected optimum biometric information is registered as reference data. In this case, by increasing the number of times biometric information is read, more appropriate biometric information can be selected as reference data. That is, after a user performs an operation for reading biometric information several times, features quantities of the biometric information obtained by a biometric information reader differ among the readings. However, when the biometric information is read from the same user, feature quantities of the biometric information are generally found within a certain range of a feature distribution. As a number of times of reading increases, biometric information found at a closer position to the center in the feature distribution can be selected. So, by applying the selected biometric information as reference data, the incidence of false authentication is reduced.

However, indefinitely increasing the number of times of reading of biometric information for registering reference data considerably deteriorates operability in the registration of reference data, and generates enormous volumes of data to be referred to in calculation for selecting optimum reference data. So, considerably a lot of time for processing is required. Therefore, from a practical point of view, the number of times of reading of biometric information for registering reference data should be limited to a certain number. Like in the above-described conventional technique, when biometric information is read several times, optimum biometric information is selected from the several pieces of biometric information, and the selected optimum biometric information is registered as it is as reference data, it cannot be confirmed whether or not the selected biometric information is appropriate information. So, if false authentication occurs frequently in actual biometric authentication performed after the reference data is registered, reference data should be registered again.

### SUMMARY OF THE INVENTION

The present invention is intended to solve the problems described above. Thus, the present invention is intended to provide a computer readable medium, an image processing system, and an image processing device capable of determining in advance whether or not biometric information selected as reference data is optimum information, and capable of optimizing reference data when the reference data to be used in biometric authentication is registered, thereby reducing the incidence of false authentication in actual biometric authentication.

First, the present invention is directed to a computer readable medium on which a program is stored. The program being executed by a computer to which a biometric information reader for performing biometric authentication is connected. The program causes the computer to operate as a system comprising: a biometric information acquisition part for acquiring N pieces of biometric information by causing the biometric information reader to read biometric information N times (N is an integer of 3 or greater); a reference data selection part for selecting one piece of biometric information from the N pieces of biometric information acquired by the biometric information acquisition part, and for provisionally setting the selected biometric information as reference data to be used in biometric authentication; an authentication test execution part for acquiring authentication-testing biometric information by causing the biometric information reader to read biometric information once, and for executing an authentication test by checking the authentication-testing biometric information against the reference data; and a reference data optimization part for selecting one piece of biometric information from (N+1) pieces of biometric information including the N pieces of biometric information acquired by the biometric information acquisition part and the authentication-testing biometric information acquired by the authentication test execution part, thereby optimizing the reference data.

Second, the present invention is directed to an image processing system comprising an image processing device with a biometric authentication function, and an information processing device for generating reference data to be used in biometric authentication in the image processing device and for registering the reference data in the image processing device. The image processing device and the information processing device are connected through a network. In this image processing system, the information processing device includes: a biometric information reader for reading biometric information; a biometric information acquisition part for acquiring N pieces of biometric information by causing the biometric information reader to read biometric information N times (N is an integer of 3 or greater); a reference data selection part for selecting one piece of biometric information from the N pieces of biometric information acquired by the biometric information acquisition part, and for provisionally setting the selected biometric information as reference data to be used in biometric authentication; an authentication test execution part for acquiring authentication-testing biometric information by causing the biometric information reader to read biometric information once, and for executing an authentication test by checking the authentication-testing biometric information against the reference data; a reference data optimization part for selecting one piece of biometric information from (N+1) pieces of biometric information including the N pieces of biometric information acquired by the biometric information acquisition part and the authentication-testing biometric information acquired by the authentication test execution part, thereby optimizing the reference data; and a reference data transmission part for transmitting the reference data optimized by the reference data optimization part to the image processing device. Further, the image processing device includes: a biometric information reader for reading biometric information; a recording part for recording therein the reference data received from the information processing device; and an authentication processor for executing biometric authentication by checking biometric information received from the biometric information reader of the image processing device against the reference data recorded in the recording part, and for enabling a function relating to image processing when biometric authentication ends in success.

Third, the present invention is directed to an image processing device with a biometric information reader, the image processing device performing biometric authentication by comparing biometric information received from the biometric information reader and reference data registered therein in advance, and enabling a function relating to image processing when the biometric authentication ends in success. The image processing device comprises: a biometric information acquisition part for acquiring N pieces of biometric information by causing the biometric information reader to read biometric information N times (N is an integer of 3 or greater); a reference data selection part for selecting one piece of biometric information from the N pieces of biometric information acquired by the biometric information acquisition part, and for provisionally setting the selected biometric information as reference data to be used in biometric authentication; an authentication test execution part for acquiring authentication-testing biometric information by causing the biometric information reader to read biometric information once, and for executing an authentication test by checking the authentication-testing biometric information against the reference data; a reference data optimization part for selecting one piece of biometric information from (N+1) pieces of biometric information including the N pieces of biometric information acquired by the biometric information acquisition part and the authentication-testing biometric information acquired by the authentication test execution part, thereby optimizing the reference data; and a reference data registration part for registering the reference data optimized by the reference data optimization part.

### BRIEF DESCRIPTION OF THE DRAWINGS

FIG. 1 shows an exemplary configuration of an image processing system;

FIG. 2 is a block diagram showing the hardware configuration of the image processing system;

FIGS. 3A and 3B show exemplary structures of a biometric information reader;

FIG. 4 is a block diagram explaining functions realized in an information processing device;

FIGS. 5A and 5B conceptually show the processing executed by a reference data selection part when the distribution of the feature quantities of three pieces of biometric information is represented two-dimensionally;

FIG. 6 conceptually shows the processing executed by an authentication test execution part when a feature distribution is represented two-dimensionally;

FIGS. 7A and 7B conceptually show the processing performed by a reference data optimization part when the distribution of the feature quantities of four pieces of biometric information is represented two-dimensionally;

FIGS. 8 and 9 are flow diagrams explaining an exemplary process sequence executed in the information processing device based on a program;

FIG. 10 is a flow diagram explaining in detail the process sequence of reference data optimization;

FIGS. 11A and 11B, FIGS. 12A and 12B, and FIGS. 13A and 13B show examples of screens displayed on a display unit during the course of the process in the information processing device;

FIG. 14 is a block diagram showing the configuration of functions in an image processing device according to a first preferred embodiment of the present invention; and

FIG. 15 is a block diagram showing the configuration of functions in an image processing device according to a second preferred embodiment of the present invention.

### DESCRIPTION OF THE PREFERRED EMBODIMENTS

Preferred embodiments of the present invention are described in detail below with reference to figures. In the description given below, those elements which are shared in common among the preferred embodiments are represented by the same reference numerals, and these elements are not discussed repeatedly for the same description.

### First Preferred Embodiment

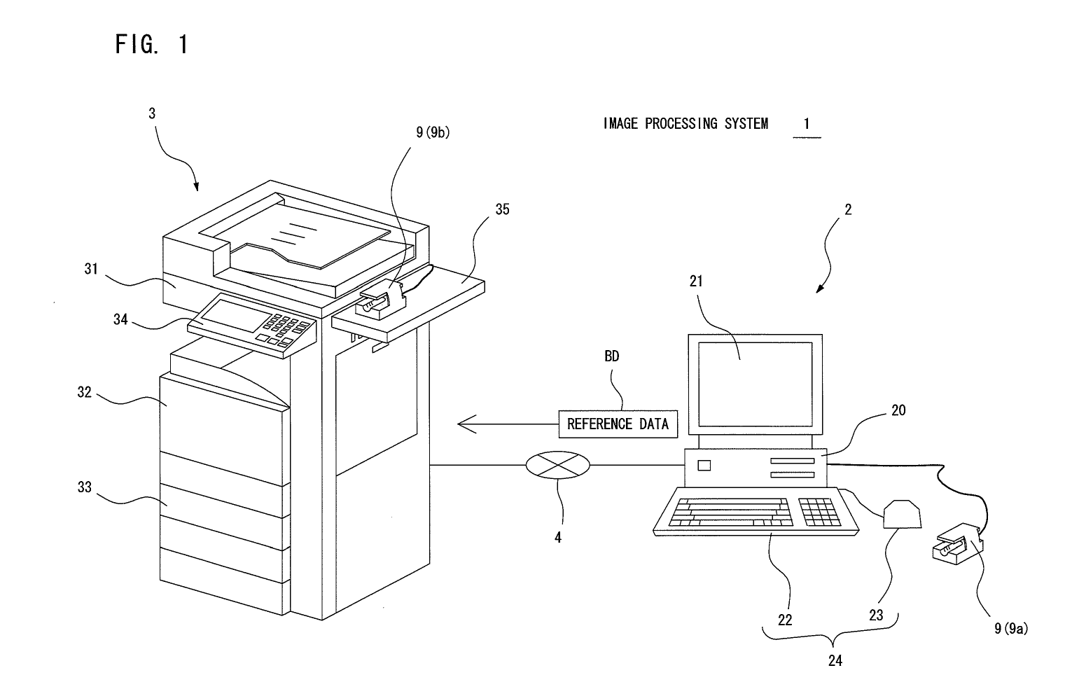

FIG. 1 shows an exemplary configuration of an image processing system 1 to which the present invention is applied. The image processing system 1 comprises an information processing device 2 constituted by a generally-used computer, and an image processing device 3 for executing a job relating to image processing. The information processing device 2 and the image processing device 3 are connected to each other through a network 4 such as LAN (Local Area Network), so that data communication between the information processing device 2 and the image processing device 3 is enabled.

The image processing device 3 is also called as an MFP (multifunction peripheral) having several functions relating to image processing such as those of a copier, a scanner, a FAX, a printer, and others. The image processing device 3 includes a scanner unit 31 set at the upper part of the device body for reading the image of a document. An operation panel 34 is set on the front side of the scanner unit 31, and which is operated by a user when the user gives instructions of job execution, etc. A printer unit 32 responsible for print output is set in the central part of the device body. A sheet feed unit 33 is set under the printer unit 32, and which keeps a stock of printing sheets and feeds sheets to the printer unit 32 when the printer unit 32 executes print output. The image processing device 3 puts each of the scanner unit 31, the printer unit 32, the sheet feed unit 33 and others into operation to execute a job relating to image processing. The image processing device 3 can also be connected to a telephone line not shown in FIG. 1, by which the image processing device 3 can transmit and receive facsimile data, for instance.

The image processing device 3 of the first preferred embodiment is so configured as to execute biometric authentication (user authentication) before a user starts using the image processing device 3. For this purpose, the image processing device 3 includes a working table 35 on a lateral side of the device body. A biometric information reader 9 (9b) is set on the working table 35. The biometric information reader 9b may be set at an alternative position, for example at the operation panel 34. The biometric information reader 9b reads a finger vein pattern as biometric information of a user who tries to use the images processing device 3. Biometric information read by the biometric information reader 9b is output to the device body of the image processing device 3, and thereafter the image processing device 3 executes biometric authentication (user authentication).

The image processing device 3 holds reference data BD which is registered for each user therein in advance to be used in biometric authentication. The image processing device 3 checks biometric information input from the biometric information reader 9b against the reference data BD registered therein in advance to execute biometric authentication. If authentication ends successfully, the image processing device 3 enables a function relating to image processing for which a user has been authorized in advance from the several functions described above such as those of a copier, a scanner, a FAX, a printer, and others. As a result, the user is allowed to use the function. If the authentication ends in failure, the image processing device 3 does not enable a function relating to image processing. So, the user is still not allowed to use a function which is imposed restriction of use in the image processing device 3.

The information processing device 2 is so configured as to generate the reference data BD to be registered in advance in the image processing device 3, and to transmit the generated reference data BD through the network 4 to the image processing device 3. The information processing device 2 is constituted by additionally connecting a biometric information reader 9 (9a) to a generally-used computer including a computer main unit 20, a display unit 21 such as a CRT (cathode ray tube) or an LCD (liquid crystal display), and a manipulation input unit 24 with a keyboard 22 and a mouse 23. The biometric information reader 9a is the same type of device as the biometric information reader 9b of the image processing device 3 for reading the finger vein pattern of a user as biometric information. In order to register a user trying to use the image processing device 3 with the information processing device 2, the biometric information reader 9a reads biometric information from the finger of the user, and outputs the read biometric information to the information processing device 2. Then, the information processing device 2 generates the reference data BD to be used in biometric authentication in the image processing device 3 based on the biometric information input from the biometric information reader 9a, and transmits the generated reference data BD to the image processing device 3.

The image processing device 3 stores therein the reference data BD received from the information processing device 2, and refers to the reference data BD at the time of biometric authentication. So, in a first preferred embodiment of the present invention, the information processing device 2 generates the reference data BD registered for each user in advance in the image processing device 3.

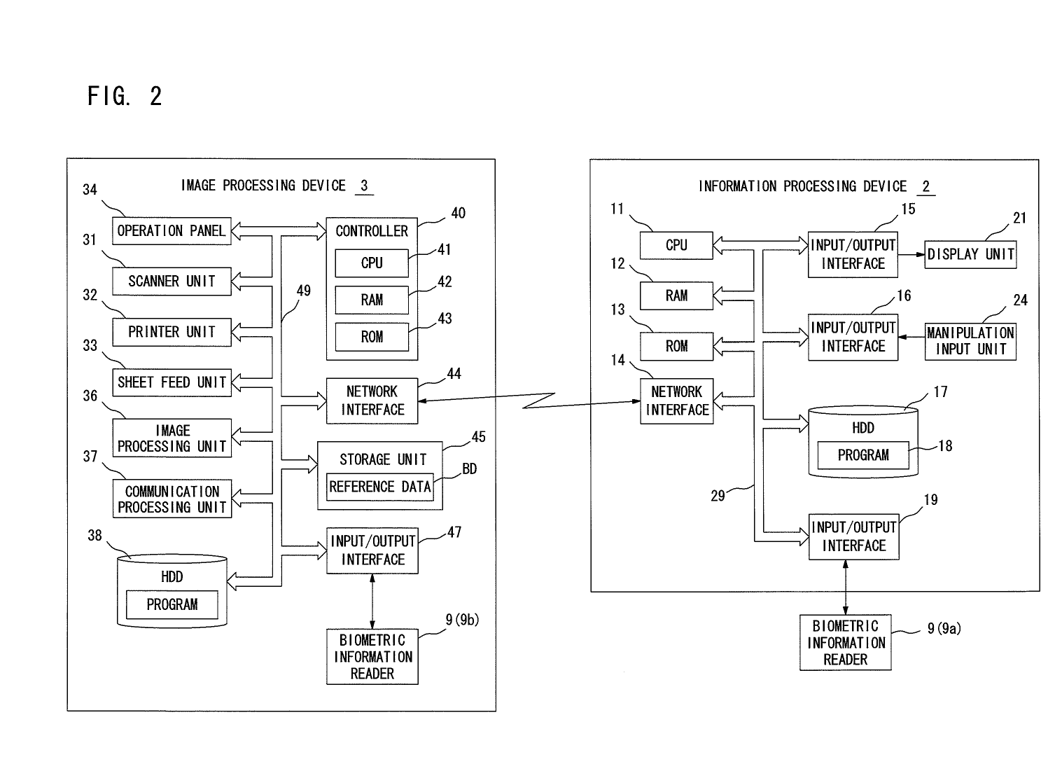

FIG. 2 is a block diagram showing the hardware configuration of the image processing system 1 of the first preferred embodiment. As shown in FIG. 2, the image processing device 3 includes the operation panel 34, the scanner unit 31, the printer unit 32, the sheet feed unit 33, an image processing unit 36, a communication processing unit 37, a hard disk drive 38, a controller 40, a network interface 44, a storage unit 45, and an input/output interface 47 that are connected to each other to allow data communication between these parts through a data bus 49. The biometric information reader 9b is connected to the input/output interface 47.

The controller 40 controls the operation of the image processing device 3 as a whole. The controller 40 includes a CPU 41, a RAM 42, and a ROM 43. The CPU 41 reads a program stored in the hard disk drive 38 and executes the program, thereby realizing each function of the controller 40. The controller 40 stores the reference data BD received from the information processing device 2 through the network interface 44 into the storage unit 45 constituted by a nonvolatile memory or the like. At the time of biometric authentication, the controller 40 inputs the biometric information of a user from the biometric information user 9b and retrieves the reference data BD from the storage unit 45, thereby executing authentication. If a user is successfully authenticated, the controller 40 enables at least one function for which the authenticated user has been authorized in advance, and controls each of the operation panel 34, the scanner unit 31, the printer unit 32, the sheet feed unit 33, the image processing unit 36 and the communication processing unit 37, thereby executing a job specified by the user. The image processing unit 36 is responsible for calculation required for executing a job such as scaling of an image, format conversion of image data and the like. The communication processing unit 37 comes into operation when transmitting and receiving facsimile data, for example.

The information processing device 2 includes a CPU 11, a RAM 12, a ROM 13, a network interface 14, input/output interfaces 15, 16 and 19, and a hard disk drive 17 that are connected to each other to allow data communication between these parts through a data bus 29. The network interface 14 is for connecting the information processing device 2 to the network 4. The input/output interfaces 15, 16 and 19 are connected to the display unit 21, the manipulation input unit 24, and the biometric information reader 9a respectively. An application program 18 for generating reference data to be used in biometric authentication is installed in advance in the hard disk drive 17. The CPU 11 reads and executes the program 18, so that the CPU 11 realizes each function described later to generate reference data BD to be transmitted to the image processing device 3. The RAM 12 temporarily holds various types of data generated while the CPU 11 executes processing based on the program 18. The ROM 13 holds data and so on stored in advance therein that is required for the CPU 11 to execute processing based on the program 18.

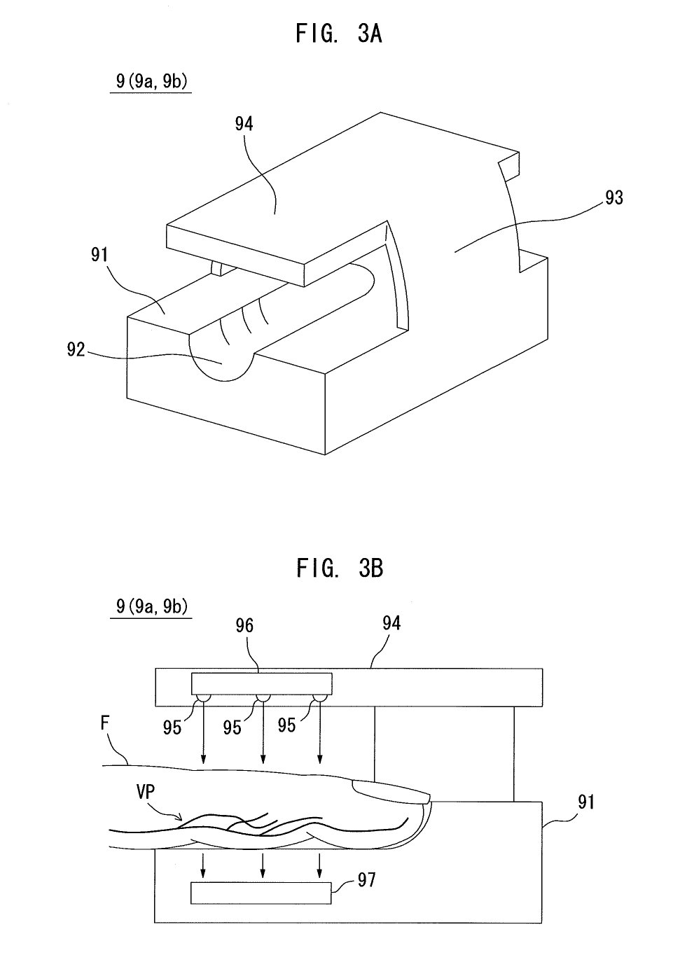

FIGS. 3A and 3B show exemplary structures of the biometric information reader 9 (9a, 9b) of the first preferred embodiment. FIG. 3A is a perspective view, and FIG. 3B is a sectional view during the use of the biometric information reader 9. As shown in FIG. 3A, the biometric information reader 9 has a recess 92 set at the central part of the front side of the main unit 91 as a base for a user to insert his or her finger into and place over. A pair of support walls 93 set on the right and left sides of the main unit 91 hold a top board 94 at a certain position above the main unit 91. As shown in FIG. 3B, the top board 94 is given a lighting unit 96 with at least one light source 95 for illuminating a finger F inserted into the recess 92 of the main unit 91 from above. The main unit 91 is given an image capturing unit 97 set lower of the internal side of the recess 92. The image capturing unit 97 receives light passing through the finger F to capture the image of a vein pattern VP of the finger F. The image captured by the image capturing unit 97 is used as biometric information. The biometric information reader 9 of the first preferred embodiment has the top board 94 set above the main unit 91 to shield environmental light such as room lighting. So, the image of the vein pattern VP is able to be captured under the condition of less affected by the environmental light when the image capturing unit 97 captures the image of the vein pattern VP. Thus, an image with a high degree of reliability can be obtained.

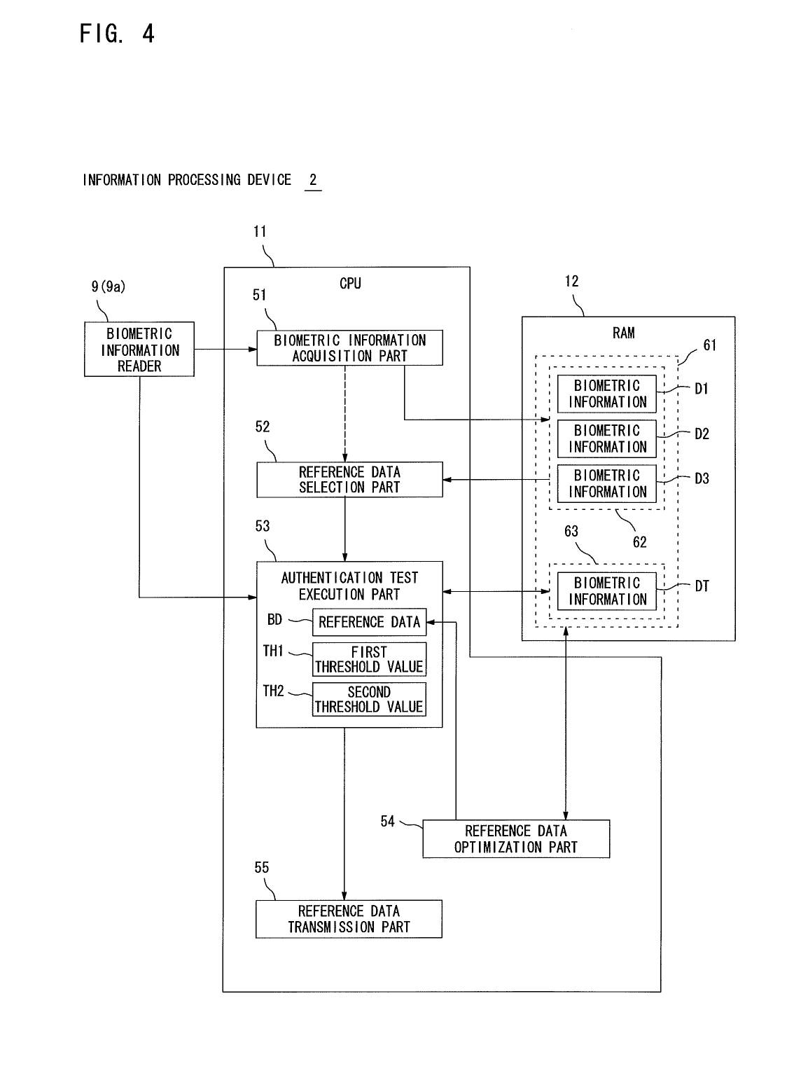

FIG. 4 is a block diagram showing each function realized by execution of the program 18 by the CPU 11 in the information processing device 2. More specifically, in order for the information processing device 2 to generate reference data to be transmitted to the image processing device 3, the CPU 11 becomes operative to function as a biometric information acquisition part 51, a reference data selection part 52, an authentication test execution part 53, a reference data optimization part 54, and a reference data transmission part 55. The RAM 12 contains a biometric information storage area 61 into which biometric information input from the biometric information reader 9a is stored. The biometric information storage area 61 has a sample storage area 62 and an authentication-testing storage area 63. Each part of the information processing device 2 is described next.

The biometric information acquisition part 51 causes the biometric information reader 9a to read biometric information N times (N is an integer of 3 or greater) to acquire N pieces of biometric information. By outputting a command to the biometric information reader 9a to start reading, the biometric information acquisition part 51 causes the biometric information reader 9a to read biometric information (capture the image of the vein pattern VP). After outputting the command, the biometric information acquisition part 51 inputs biometric information obtained by reading the finger vein pattern of a user from the biometric information reader 9a, and stores the input biometric information into the sample storage area 62 in the RAM 12. The sample storage area 62 can hold N pieces of biometric information. The biometric information acquisition part 51 repeats command output and storage of biometric information input as a result of the corresponding command output N times, thereby storing N pieces of biometric information into the sample storage area 62.

When the biometric information acquisition part 51 acquires biometric information obtained by being read N times from the biometric information reader 9a, a user's finger is preferably taken off the biometric information reader 9a after each reading. So, after each reading, a guidance screen prompting the user to take the finger off the biometric information reader 9a may be displayed on the display unit 21, for example.

In the first preferred embodiment described below, N is assumed to be three. Accordingly, the biometric information reader 9a reads biometric information three times. Then, the biometric information acquisition part 51 inputs three pieces of biometric information from the biometric information reader 9a separately, and stores the input biometric information in order into the sample storage area 62. As a result, three pieces of biometric information D1, D2 and D3 are stored in the sample storage area 62.

The reference data selection part 52 selects one piece of biometric information from the N pieces (in the first preferred embodiment, three pieces) of biometric information D1, D2 and D3 acquired by the biometric information acquisition part 51, and provisionally sets the selected biometric information as reference data to be used in biometric authentication. The reference data selection part 52 first reads the three pieces of biometric information D1, D2 and D3 stored in the sample storage area 62, and calculates the respective feature quantities of the biometric information D1, D2 and D3. For instance, an image captured by the biometric information reader 9a includes a vein pattern as a linear pattern. Then, the reference data selection part 52 first extracts the linear pattern from the image. The reference data selection part 52 then calculates features such as the number of lines and the density of lines constitute the linear pattern, the number of points of intersection of the lines, or the positions of the points of intersection, and sets these values as the feature quantity, for example. That is, in the first preferred embodiment, the feature quantity of biometric information contains several types of data. The feature quantity is not necessarily limited to these values, but may contain other values.

After calculating the respective feature quantities of the three pieces of biometric information D1, D2 and D3, the reference data selection part 52 evaluates the feature quantity of each of the biometric information D1, D2 and D3, and selects one piece of biometric information optimally applied to be used in biometric authentication. In the first preferred embodiment, one piece of biometric information is selected based on the distribution of the respective feature quantities of the biometric information D1, D2 and D3. As an example, when the feature quantity contains several types of data, and virtual multi-dimensional space with the number of dimensions corresponding to the number of types of data is given, the feature quantity of each of the biometric information D1, D2 and D3 is found at a position defined by coordinate values corresponding to the respective values of the several types of data of each feature quantity. Then, the reference data selection part 52 selects one piece of biometric information found at the closest position to the center in this feature distribution.

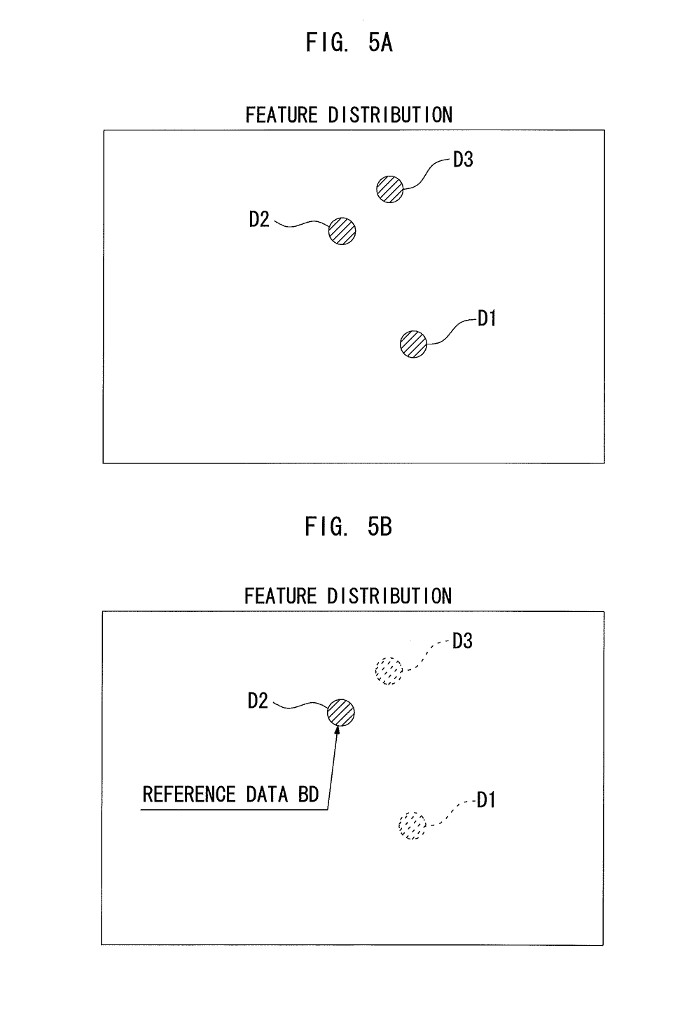

FIGS. 5A and 5B conceptually show the processing executed by the reference data selection part 52 when the distribution of the respective feature quantities of the biometric information D1, D2 and D3 is represented two-dimensionally. When the three feature quantities respectively calculated from the three pieces of biometric information D1, D2 and D3 found as shown in FIG. 5A, the reference data selection part 52 selects one piece of biometric information found at the closest position to the center in the distribution of the three feature quantities. As an example, with regard to each of the three pieces of biometric information D1, D2 and D3, the reference data selection part 52 calculates the sum of the squares of distances from the feature quantity of one piece of the biometric information D1, D2 and D3 to other feature quantities of the remaining pieces of the biometric information D1, D2 and D3. Then, the reference data selection part 52 determines biometric information which has the smallest value of sum as the one found at the closest position to the center of the three pieces of biometric information. So, in the case of FIG. 5A, the feature quantity of the biometric information D2 is determined to be at a position nearest to the center as shown in FIG. 5B after the calculation described above is executed. Then, the reference data selection part 52 selects the biometric information D2, and provisionally sets the biometric information D2 thereby selected as the reference data BD.

After the reference data selection part 52 provisionally sets the reference data BD, the reference data BD is transmitted to the authentication test execution part 53. Next, the authentication test execution part 53 comes into operation.

The authentication text execution part 53 causes the biometric information reader 9a to read biometric information once to acquire authentication-testing biometric information, and executes an authentication test by checking the authentication-testing biometric information thereby acquired against the reference data BD. As well as the biometric information acquisition part 51, by outputting a command to the biometric information reader 9a to start reading, the authentication test execution part 53 causes the biometric information reader 9a to read biometric information. After outputting the command, the authentication test execution part 53 inputs the authentication-testing biometric information DT obtained by reading the finger vein pattern of a user from the biometric information reader 9a, and stores the input biometric information DT into the authentication-testing storage area 63 in the RAM 12. The authentication-testing storage area 63 can hold only one piece of authentication-testing biometric information DT.

Thereafter the authentication test execution part 53 compares the authentication-testing biometric information DT and the reference data BD to execute an authentication test. More specifically, the authentication test execution part 53 calculates the feature quantity of the authentication-testing biometric information DT, and compares the calculated feature quantity with the feature quantity of the reference data BD. This comparison in the feature distribution is also made.

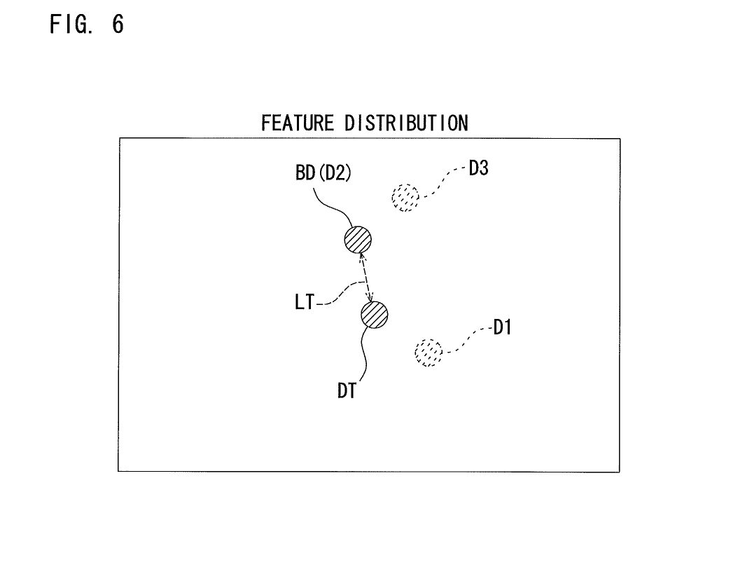

FIG. 6 conceptually shows the processing executed by the authentication test execution part 53 when the feature distribution is represented two-dimensionally. When the respective feature quantities of the authentication-testing biometric information DT and the reference data BD found as shown in FIG. 6, the authentication test execution part 53 obtains a distance LT between these two feature quantities. Then, based on the distance LT, the authentication test execution part 53 determines whether or not a user who entered the authentication-testing biometric information DT is the same user as the one who entered the biometric information D2 corresponding to the reference data BD, thereby authenticating the user.

In order to execute this authentication, the authentication test execution part 53 holds first and second threshold values TH1 and TH2 as shown in FIG. 4. The first and second threshold values TH1 and TH2 are values predetermined to reach the relation as the first threshold value TH1 being greater than the second threshold value TH2 between each other.

The first threshold value TH1 is used to determine whether the authentication results in success or failure. If the distance LT between the feature quantities of the authentication-testing biometric information DT and the reference data BD shown in FIG. 6 is equal to or not greater than the first threshold value TH1, the authentication-testing biometric information DT is close to the reference data BD. So, the authentication results in success in this case. In contrast, if the distance LT is greater than the first threshold value TH1, the authentication-testing biometric information DT is not close to the reference data BD. So, authentication results in failure in this case. That is, whether the authentication executed by the authentication test execution part 53 results in success or failure is determined by the comparison between the distance LT between the feature quantities of the authentication-testing biometric information DT and the reference data BD, and the first threshold value TH1.

The second threshold value TH2 is used to evaluate the reliability of the reference data BD when authentication results in success in the authentication test. It is assumed that the distance LT between the feature quantities of the authentication-testing biometric information DT and the reference data BD is greater than the second threshold value TH2, but is equal to or not greater than the first threshold value TH1. In this case, even though authentication results in success in the authentication test, the feature quantity of the authentication-testing biometric information DT is found at a position slightly inside a range of which authentication is deemed to be successful. Thus, authentication may result in failure in a next test due to the posture of a finger, for example. The degree of reliability of the reference data BD may be low in this case. So, when the reference data BD registered as the one to be used in actual biometric authentication, false authentication may occur often.

In contrast, it is assumed that the distance LT is equal to or not greater than the second threshold value TH2. In this case, authentication results in success in the authentication test, and the feature quantity of the authentication-testing biometric information DT is found at a position sufficiently inside the range of which authentication is deemed to be successful. So, the reference data BD is proved to be appropriate reference data to be used in actual biometric authentication.

After executing the authentication test described above, the authentication test execution part 53 displays a result of authentication on the display unit 21. Even when authentication results in success but the degree of reliability of the reference data BD is low, the authentication test execution part 53 displays notification prompting a user to execute the authentication test again. If authentication results in failure, or if the user instructs to perform the authentication test again, the authentication test execution part 53 repeats the authentication test described above.

The reference data optimization part 54 comes into operation after the authentication test execution part 53 executes the authentication test described above at least once. The reference data optimization part 54 selects one piece of biometric information from (N+1) pieces (in the first preferred embodiment, four pieces) of biometric information including the N pieces (in the first preferred embodiment, three pieces) of biometric information D1, D2 and D3 acquired by the biometric information acquisition part 51 and stored in the sample storage area 62, and the authentication-testing biometric information DT acquired by the authentication test execution part 53 and stored in the authentication-testing storage area 63, thereby optimizing the reference data BD. That is, the reference data optimization part 54 calculates the respective feature quantities of the four pieces of biometric information D1, D2 and D3, and of the authentication-testing biometric information DT in the same way as described above, and evaluates the calculated feature quantities. Thereafter the reference data optimization part 54 selects one piece of biometric information from the four pieces of biometric information D1, D2, D3 and DT, and sets the selected biometric information as the reference data BD again. This makes the reference data BD to come closer to the center in the distribution of the feature quantities of biometric information, thereby optimizing the reference data BD.

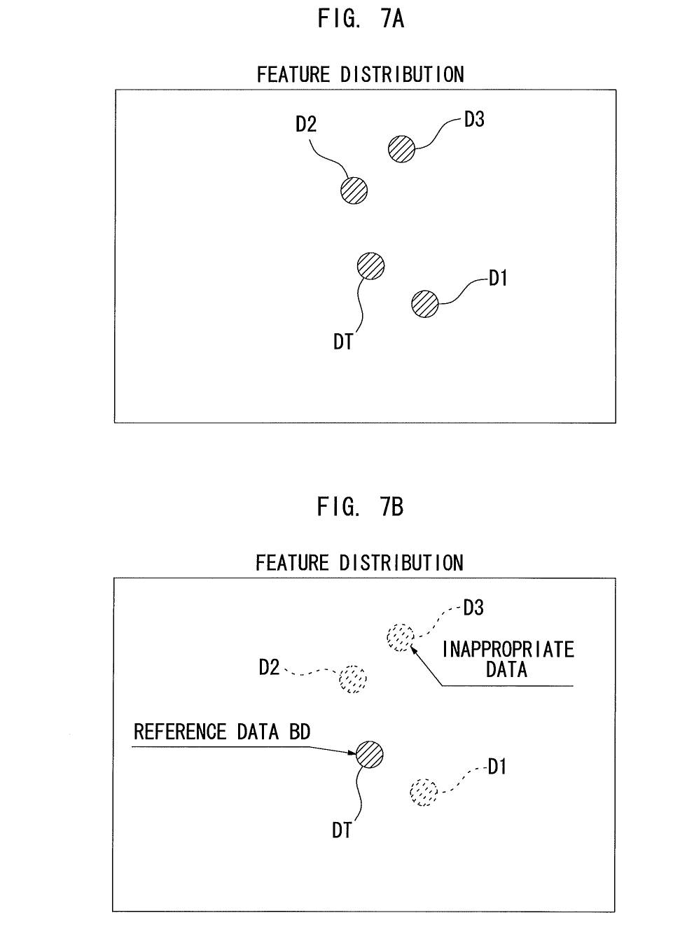

FIGS. 7A and 7B conceptually show the processing executed by the reference data optimization part 54 when the distribution of the respective feature quantities of the biometric information D1, D2, D3 and DT is represented two-dimensionally. When the four feature quantities respectively calculated from the four pieces of biometric information D1, D2, D3 and DT are found as shown in FIG. 7A, the reference data optimization part 54 selects one piece of biometric information found at the closest position to the center in the distribution among the four feature quantities. This selection is described in more detail as follows. As well as the processing executed by the reference data selection part 52, with regard to each of the four pieces of biometric information D1, D2, D3 and DT, the reference data optimization part 54 calculates the sum of the squares of distances from the feature quantity of one piece of the biometric information D1, D2, D3 and DT to other feature quantities of the remaining pieces of the biometric information D1, D2, D3 and DT. Then, the reference data optimization part 54 determines that biometric information the sum of which is the smallest as the one found at the closest position to the center of the four pieces of biometric information. So, in the case of FIG. 7A, by executing the above described calculation, the feature quantity of the biometric information DT acquired to be used in the authentication test is determined to be at the closest position to the center as shown in FIG. 7B. Then, the reference data optimization part 54 selects the biometric information DT, and sets the biometric information DT thereby selected as the reference data BD again. This processing makes the reference data BD to come closer to the center in the feature distribution, so that this reference data BD has a higher degree of appropriateness than the reference data used in the previous authentication test has. Thus, when the reference data BD optimized by the reference data optimization part 54 is applied as the reference data BD to be used in actual biometric authentication, the frequency of the occurrence of false authentication may be decreased in actual biometric authentication compared with the case where reference data selected by the reference data selection part 52 is applied. By repeating the process described above, the reference data BD will have a higher and higher degree of appropriateness.

After the reference data BD is optimized in the manner described above, the reference data optimization part 54 selects one piece of biometric information as inappropriate data from the four pieces of biometric information. In contrast to the optimization of the reference data BD, biometric information corresponding to a feature quantity found at the farthest position from the center in the distribution of the feature quantities of the four pieces of biometric information is selected here. That is, of the four pieces of biometric information D1, D2, D3 and DT for which respective feature quantities are calculated, one piece of biometric information is selected that has a maximum sum of the squares of distances from its feature quantity to other feature quantities of the remaining pieces of the biometric information D1, D2, D3 and DT. So, biometric information that has the lowest degree of appropriateness to be set as reference data is selected from the four pieces of biometric information D1, D2, D3 and DT as inappropriate data. In the case of FIG. 7A, for example, the feature quantity of the biometric information D3 is determined to be at the farthest position from the center as shown in FIG. 7B by executing the calculation described above. So, the biometric information D3 is selected as inappropriate data. Then, the reference data optimization part 54 deletes the biometric information selected as inappropriate data from the biometric information storage area 61, and stores the remaining three pieces of biometric information into the sample storage area 62.

As described above, the reference data optimization part 54 selects inappropriate data from the four pieces of biometric information D1, D2, D3 and DT, and deletes the selected inappropriate data. So, for optimizing reference data again even after the authentication test execution part 53 executes the authentication test several times, the reference data optimization part 54 selects the optimum reference data BD from the four pieces of biometric information D1, D2, D3 and DT as described above. That is, the reference data optimization part 54 does not need to refer to more than four pieces of biometric information D1, D2, D3 and DT for optimization. This advantageously realizes efficient processing, leading to shorter time required for the optimization. This advantage is also taken when the function of the reference data optimization art part 54 is realized in hardware. In this case, the number of pieces of data to be referred to is fixed at four, and hardware configuration is easy to be developed.

The reference data transmission part 55 transmits the reference data BD optimized by the reference data optimization part 54 as described above to the image processing device 3, and registers the reference data BD as the one to be used in actual biometric authentication in the image processing device 3. When the reference data optimization part 54 does not optimize the reference data BD, the reference data BD provisionally set by the reference data selection part 52 is transmitted as it is to the image processing device 3.

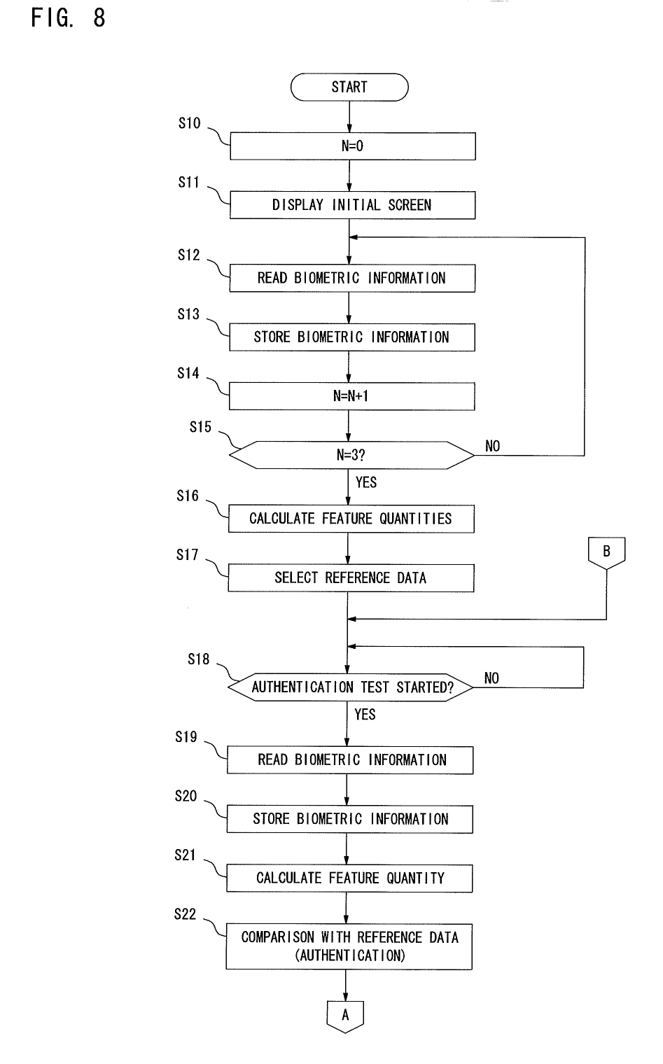

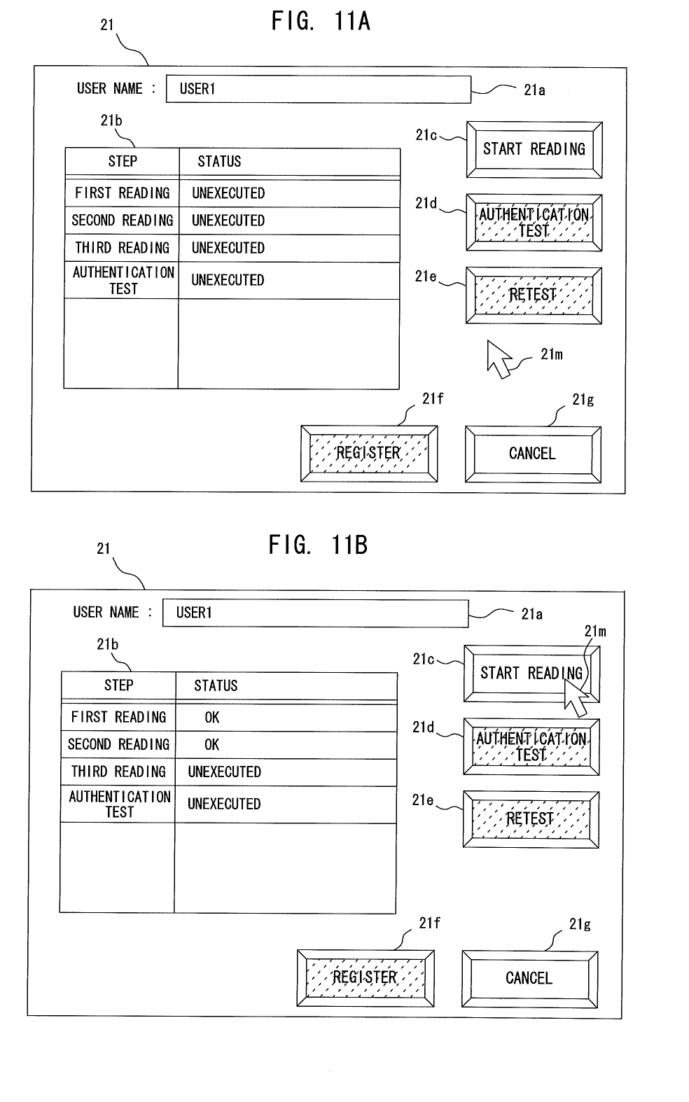

Next, the operation of the information processing device 2 is described in detail. FIGS. 8 to 10 are flow diagrams explaining an exemplary process sequence executed by the CPU 11 in the information processing device 2 based on the program 18. FIGS. 11A and 11B, FIGS. 12A and 12B, and FIGS. 13A and 13B show examples of screens displayed on the display unit 21 during the course of the process.

Upon the start of the process based on the program 18 in the information processing device 2, a count N is reset to “zero” (step S10) at first, and an initial screen is displayed on the display unit 21 (step S11). FIG. 11A shows an example of the initial screen. A user who intends to register the reference data BD operates the manipulation input unit 24 to enter his or her own user name and the like into a user name entry field 21a, operates the mouse 23 to move a pointer 21m, and clicks a start reading button 21c, thereby starting the reading of biometric information. The screen on the display unit 21 includes an information display field 21b for displaying the status of process of registering reference data, etc. In the initial state, the screen shows that the reading operation of biometric information is unexecuted. Also, the screen shows an authentication test button 21d, a retest button 21e, a register button 21f, and a cancel button 21g operable by a user. The authentication test button 21d, the retest button 21e and the register button 21f are shown to be inoperable in the initial state of the screen. The cancel button 21g is intended for example to complete the execution of the program 18.

A user clicks the start reading button 21c with placing his or her finger over the biometric information reader 9a (see FIG. 3B), in response to which the information processing device 2 reads biometric information once (step S12). If biometric information is successfully acquired, the information processing device 2 stores the acquired biometric information into the sample storage area 62 (step S13). Then, the information processing device 2 increments the count N by “one” (step S14), and determines whether or not the count N has reached “three” (step S15). If the count N has not reached “three,” the information processing device 2 repeats the process from steps S12 to S14 until the count N reaches “three.” As a result, three pieces of biometric information D1, D2 and D3 are stored in the sample storage area 62. When biometric information is read repeatedly, the user preferably takes the finger off the biometric information reader 9a after each reading.

FIG. 11B shows a display screen at the time of biometric information is read twice. The state that “OK” is shown after each reading means that a linear pattern (vein pattern) has successfully been extracted from the read biometric information. So, when the state that “NG” is shown after the reading, the user is required to perform reading operation of biometric information again.

After biometric information is successfully read three times (if a result of step S15 is YES), an operation for calculating the respective feature quantities of the three pieces of biometric information D1, D2 and D3 follows (step S16). After the respective feature quantities are calculated, one piece of biometric information is selected based on the distribution of the respective feature quantities of the three pieces of biometric information D1, D2 and D3. Thereafter the selected biometric information is provisionally set as the reference data BD (step S17).

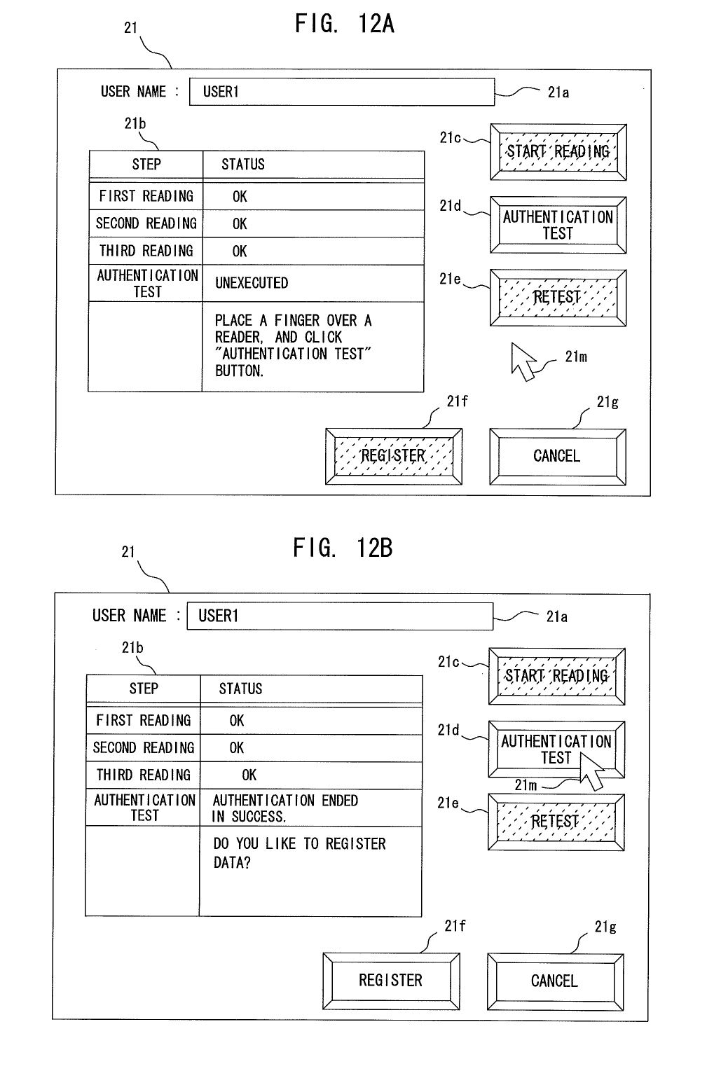

The display screen on the display unit 21 at this stage is the one shown in FIG. 12A. In this screen, the start reading button 21c becomes inoperable, while the authentication test button 21d becomes operable. Further, information prompting the user to perform an authentication test appears in the information display field 21b. Then, the user clicks the authentication test button 21d with the mouse 23, by which the information processing device 2 is instructed to start the authentication test.

The information processing device 2 is placed in standby until an instruction to start the authentication test is given (step S18). When the user clicks the authentication test button 21d with placing his or her finger over the biometric information reader 9a (if a result of step S18 is YES), the information processing device 2 reads biometric information once (step S19). Then, the information processing device 2 stores the biometric information DT thereby acquired into the authentication-testing storage area 63 (step S20). Thereafter the information processing device 2 executes an operation for calculating the feature quantity of the authentication-testing biometric information DT (step S21). After the calculation, the information processing device 2 compares the feature quantity of the authentication-testing biometric information DT with that of the reference data BD set at this stage to authenticate the user (step S22). In step S22, the distance LT between two feature quantities is obtained in the feature distribution, and the obtained distance LT and the first threshold value TH1 are compared as described, thereby authenticating the user. At this time, the distance LT is also compared with the second threshold value TH2.

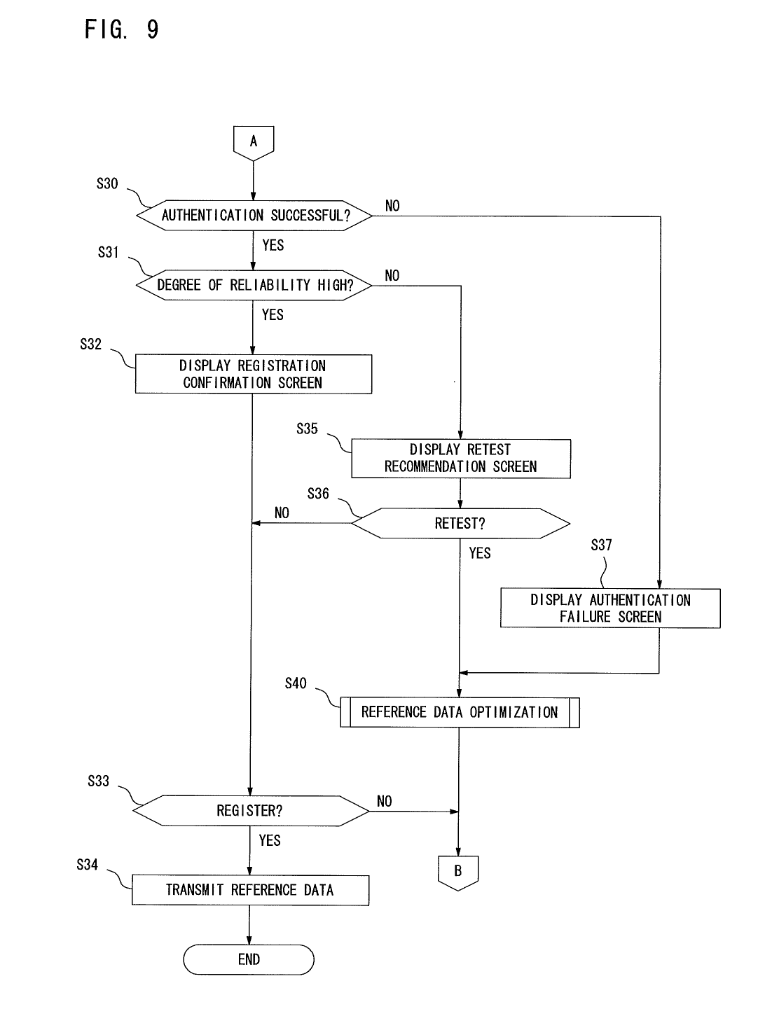

Next, with reference to the flow diagram of FIG. 9, it is determined whether or not the authentication ends in success (step S30). If it is determined that the authentication ends in failure (if a result of step S30 is NO), the flow moves on to step S37 in which an authentication failure screen is displayed on the display unit 21. If it is determined that the authentication ends in success (if a result of step S30 is YES), it is also determined whether or not the reference data BD set at this stage has a high degree of reliability (step S31). This determination is made based on a result of comparison between the distance LT and the second threshold value TH2. If the reference data BD is determined to have a high degree of reliability (if a result of step S31 is YES), the flow moves on to step S32 in which a registration confirmation screen is displayed on the display unit 21. If the reference data BD is determined to have a low degree of reliability (if a result of step S31 is NO), the flow moves on to step S35 in which a retest recommendation screen is displayed on the display unit 21.

FIG. 12B is an example of the registration confirmation screen displayed in step S32. This registration confirmation screen is displayed when the authentication ends in success in the authentication test, and when the reference data BD set at this stage has a high degree of reliability. So, a sign checking to see whether or not the reference data BD set at this stage is to be registered appears in the information display field 21b. In order to register the reference data BD, the user clicks the register button 21f. The authentication test can also be performed repeatedly on this registration confirmation screen. If the user wants to perform the authentication test again, the user clicks the authentication test button 21d.

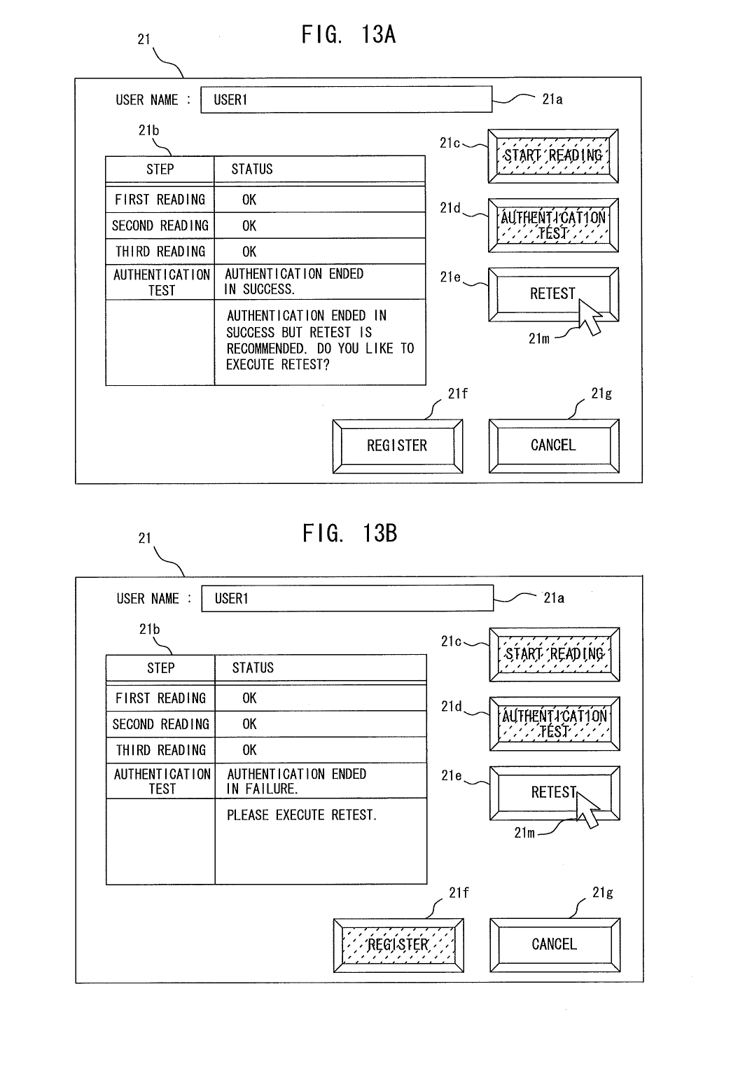

FIG. 13A is an example of the retest recommendation screen displayed in step S35. This retest recommendation screen is displayed when the authentication ends in success in the authentication test, but when the reference data BD set at this stage is determined to have a low degree of reliability. So, a sign prompting the user to perform a retest appears in the information display field 21b. If the user would like to perform a retest, the user clicks the retest button 21e. The authentication ends in success in the authentication test even when the retest recommendation screen is displayed. Therefore the user may register the reference data BD set at this stage as it is. The user clicks the register button 21f in order to register the reference data BD at this stage.

FIG. 13B is an example of the authentication failure screen displayed in step S37. This authentication failure screen is displayed when authentication results in failure in the authentication test. So, the reference data BD set at this stage cannot be registered as it is, and the register button 21f is shown to be inoperable. Thus, the user should perform the authentication test again by clicking the retest button 21e.

Returning to FIG. 9, after displaying the record confirmation screen in step S32, the information processing device 2 determines whether or not the register button 21f has been clicked (step S33). If the register button 21f was clicked, the information processing device 2 transmits the reference data BD set at this stage to the image processing device 3, and registers the transmitted reference data BD in the image processing device 3 (step S34). In contrast, if the user clicks the authentication test button 21d, a result of step S33 is NO. So, the flow returns to step S18 of FIG. 8 to start the authentication test again.

When the retest recommendation screen is displayed in step S35, the information processing device 2 determines whether or not the retest button 21e has been clicked (step S36). If the retest button 21e was clicked (if a result of step S36 is YES), the information processing device 2 executes reference data optimization (step S40) as described in detail later. After the reference data optimization (step S40), the flow returns to step S18 of FIG. 8 to start the authentication test again. In contrast, if the register button 21f was clicked on the retest recommendation screen, a result of step S36 is NO, and a result of step S33 is YES. So, the information processing device 2 transmits the reference data BD set at this stage to the image processing device 3, and registers the transmitted reference data BD in the image processing device 3 (step S34).

When the authentication failure screen is displayed in step S37, the information processing device 2 is caused to execute the reference data optimization by the click of the retest button 21e (step S40). After the reference data optimization (step S40), the flow returns to step S18 to start the authentication test again.

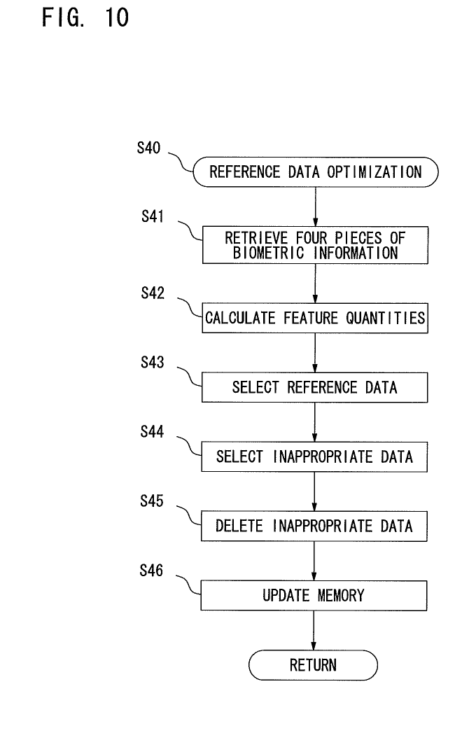

FIG. 10 is a flow diagram explaining the process sequence of the reference data optimization (step S40) in detail. When the reference data optimization is started, the information processing device 2 retrieves the four pieces of biometric information D1, D2, D3 and DT from the RAM 12 (step S41), and calculates the respective feature quantities of the biometric information D1, D2, D3 and DT (step S42). When the feature quantities calculated in steps S16 and S21 are held for example in the RAM 12, the processing of step S42 is not necessary to be executed. Then, based on the respective feature quantities of the four pieces of biometric information D1, D2, D3 and DT, one appropriate piece of biometric information is selected from the four pieces of biometric information D1, D2, D3 and DT, and the selected biometric information is set as the reference data BD again. Thus, biometric information having a feature quantity found at the closest position to the center in the distribution of the feature quantities is selected and then set as the reference data BD, thereby optimizing the reference data BD.

After the more appropriate reference data BD is selected, the information processing device 2 selects one piece of biometric information as inappropriate data from the four pieces of biometric information D1, D2, D3 and DT (step S44), and deletes the selected biometric information corresponding to the inappropriate data from the biometric information storage area 61 (step S45), thereby updating the biometric information storage area 61 in the RAM 12 (step S46). The reference data optimization (step S40) is completed here.

The process sequence described above allows to execute the authentication test repeatedly. By sequentially repeating the authentication test and the reference data optimization (step S40), the reference data BD becomes the one having a higher degree of appropriateness. This works especially on the case where the authentication ends in failure in the authentication test. In this case, while the reference data BD set at the stage of failure may not be appropriate data, the reference data optimization (step S40) is executed without fail. So, data having a higher degree of appropriateness can be set again as the reference data BD. In the example described above, the reference data optimization (step S40) is not performed if the information processing device 2 is instructed to execute the authentication test again in a condition where the authentication test results in success, and the degree of reliability of the reference BD is determined to be high. However, the reference data optimization (step S40) may also be executed in this case.

As described above, in the information processing device 2 of the first preferred embodiment, one piece of biometric information is selected from the three pieces of biometric information D1, D2 and D3 acquired first as a result of three times of reading operations, and the selected biometric information is provisionally set as the reference data BD. Thereafter the authentication test is executed to determine whether or not the reference data BD provisionally set has the highest degree of appropriateness. If the reference data BD provisionally set does not have the highest degree of appropriateness, the reference data BD having a higher degree of appropriateness is selected from the four pieces of biometric information D1, D2 and D3, and DT acquired to be used in the authentication test. Thus, the reference data BD can be optimized before being registered in the image processing device 3.

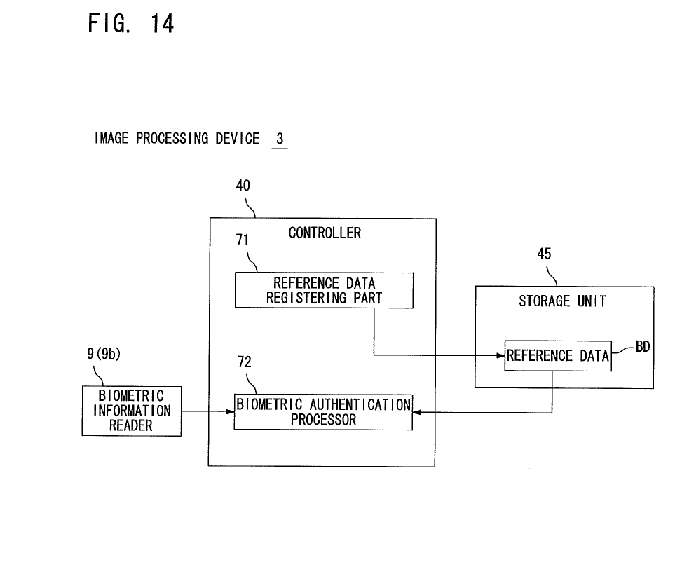

FIG. 14 is a block diagram showing the configuration of functions in the controller 40 of the image processing device 3. As shown in FIG. 14, the controller 40 of the image processing device 3 functions as a reference data registering part 71 and a biometric authentication processor 72.

The reference data registering part 71 receives the reference data BD generated by the information processing device 2 by executing the process described above through the network 4, and stores the received reference data BD into the storage unit 45.

The biometric authentication processor 72 acquires the biometric information of a user who tries to use the image processing device 3 from the biometric information reader 9b, and compares the acquired biometric information with the reference data BD stored in the storage unit 45, thereby authenticating the user. This authentication follows the same process as that of the authentication in the authentication test executed by the information processing device 2. That is, the biometric authentication processor 72 holds the first threshold value TH1 applied for executing the authentication. If the distance LT between the feature quantities of the biometric information acquired from the biometric information reader 9b and the reference data BD is equal to or not greater than the first threshold value TH1, it is determined the authentication ends in success. If the distance LT is greater than the first threshold value TH1, it is determined the authentication ends in failure.

When it is determined that the authentication ends in success, the biometric authentication processor 72 enables a function relating to image processing for which an authenticated user has been authorized in advance, thereby allowing a user to use the image processing device 3.

The reference data BD referred to in this actual biometric authentication in the image processing device 3 has been optimized as a result of the above-described processing executed in the information processing device 2. So, compared to conventional biometric authentication, this reduces the incidence of false authentication in which causing authentication of a user to be ended in failure even when the user is a rightful user. Thus, when user authentication in the image processing device 3 employs biometric authentication as in the first preferred embodiment, the security level of the image processing device 3 is raised without deteriorating the operability of the image processing device 3.

As described above, according to the first preferred embodiment, one piece of biometric information is selected from N pieces of biometric information, and the selected biometric information is provisionally set as reference data. Thereafter biometric information to be used in an authentication test is acquired to execute the authentication test. So, the appropriateness of the reference data provisionally set is determined. Further, one piece of biometric information is selected from (N+1) pieces of biometric information including the N pieces of biometric information, and the authentication-testing biometric information, and the reference data is optimized. So, data having a higher degree of appropriateness than the reference data provisionally set is set as reference data. As a result, it may determine in advance whether or not biometric information has the highest degree of appropriateness is selected as the reference data, and the reference data can be optimized at the time of registering the reference data to be used in biometric authentication. Thus, the incidence of false authentication in actual biometric authentication can be reduced compared to conventional biometric authentication.

### Second Preferred Embodiment

A second preferred embodiment of the present invention is described next. In the first preferred embodiment described above, the reference data BD to be used in actual biometric authentication in the image processing device 3 is generated in the information processing device 2 set separately from the image processing device 3. In the second preferred embodiment, the above-described function of the information processing device 2 is incorporated as it is into an image processing device, so the image processing device can independently register the reference data BD, and optimize the reference data BD.

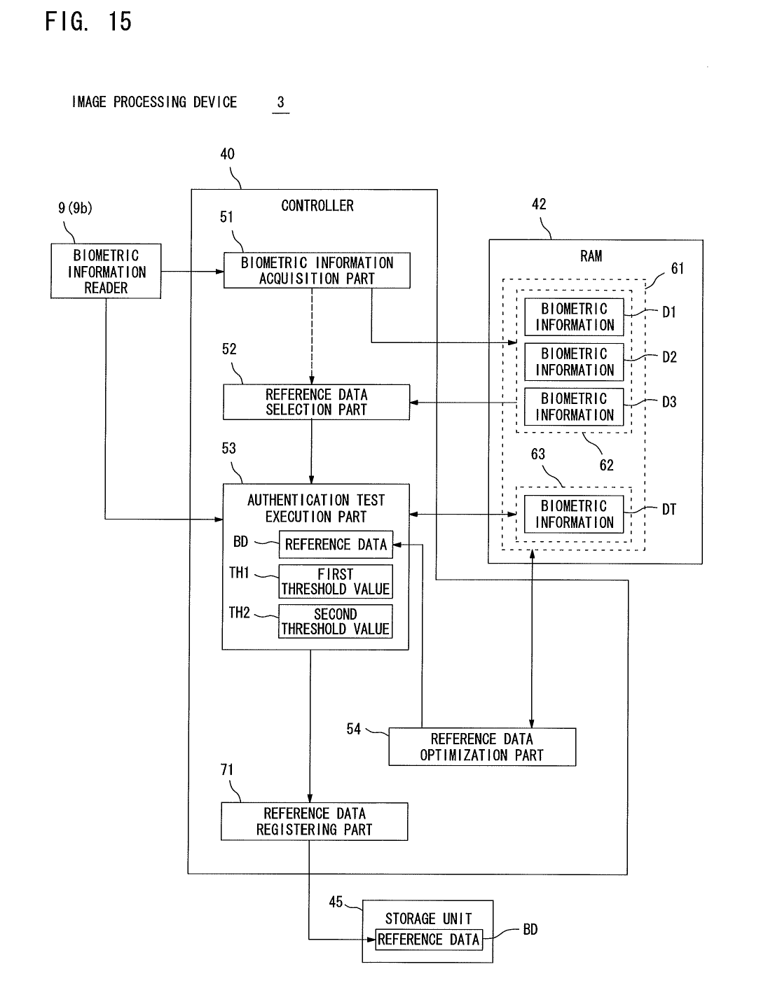

FIG. 15 is a block diagram showing the configuration of functions in the controller 40 of the image processing device 3 according to the second preferred embodiment. In the second preferred embodiment, the CPU 41 in the controller 40 executes the program stored in the hard disk drive 38 (see FIG. 2), in response to which the controller 40 becomes operative to function in a way shown in FIG. 15. That is, when the reference data BD to be used in actual biometric authentication is registered in the image processing device 3, the controller 40 of the second preferred embodiment becomes operative to function as the biometric information acquisition part 51, the reference data selection part 52, the authentication test execution part 53, the reference data optimization part 54, and the reference data registering part 71. The detail of each of these parts is the same as that described in the first preferred embodiment. The process sequence executed by bringing each part into operation is also the same as that shown in the flow diagrams explained in the first preferred embodiment.

Therefore, in the image processing device 3 of the second preferred embodiment, when the reference data BD is registered, the three pieces of biometric information D1, D2 and D3 are acquired first from the biometric information reader 9b. Then, one piece of biometric information is selected from the three pieces of biometric information, and the selected biometric information is provisionally set as the reference data BD. Thereafter an authentication test is executed to determine whether or not the reference data BD provisionally set is appropriate data. If the reference data provisionally set is not appropriate data, another piece of biometric information has higher degree of appropriateness is selected from the four pieces of biometric information including the three pieces of biometric information D1, D2 and D2, and the biometric information DT acquired to be used in an authentication test, and the selected biometric information is set as the reference data BD. Finally, the reference data registering part 71 stores the optimized reference data BD into the storage unit 45.

In actual biometric authentication in the image processing device 3, user authentication is executed by making reference to the optimized reference data BD stored in the storage unit 45. So, compared to conventional biometric authentication, this reduces the incidence of false authentication in which authentication of a user ends in failure even when the user is a rightful user.

As described, in the second preferred embodiment, the reference data BD to be used in biometric authentication is registered after being optimized even when the image processing device 3 is set independently. Thus, the second preferred embodiment can preferably be applied to the case where the image processing device 3 is used independently.

In order to incorporate the function of the information processing device 2 described in the first preferred embodiment into the image processing device 3, each part shown in FIG. 15 may be realized in hardware. In this case, the number of pieces of biometric information to be referred to in each part can always be fixed at a certain number, thereby making hardware configuration relatively easy.

### (Modifications)

While the preferred embodiments of the present invention have been described above, the present invention is not limited to these preferred embodiments. Various modifications may be applied to the present invention. By way of example, in the preferred embodiments described above, the reading of the finger vein pattern of a user is explained as an exemplary way of biometric authentication. A palm vein pattern may alternatively be read. Still alternatively, a fingerprint may be read as biometric information other than a vein pattern.

In the preferred embodiments described above, the number of times N that biometric information is read at first in order to set the reference data BD is predetermined at “three.” The number N can suitably be set in consideration of the time required for calculation, etc. However, in the above-described preferred embodiments, one piece of biometric information found at the closest position to the center in the distribution of the features quantities of the N pieces of biometric information is selected. So, the number N should be an integer of 3 or greater.

In the preferred embodiments described above, the image processing device 3 is shown to be a device having several functions relating to image processing such as those of a copier, a scanner, a FAX, a printer, and others. However, the image processing device 3 is not necessarily a device having several functions. The image processing device 3 may be a copier-only device or a scanner-only device. Moreover, the image processing device 3 may be a FAX-only device or a printer-only device. Still alternatively, the image processing device 3 may be a device has an image processing function except those described above.

While the invention has been shown and described in detail, the foregoing description is in all aspects illustrative and not restrictive. It is therefore understood that numerous modifications and variations can be devised without departing from the scope of the invention.

What is claimed is:

1. A computer readable medium on which a program is stored, said program being executed by a computer to which a biometric information reader for performing biometric authentication is connected, said program causing said computer to operate as a system comprising:
a biometric information acquisition part for acquiring N pieces of biometric information by causing said biometric information reader to read biometric information N times (N is an integer of 3 or greater);
a reference data selection part for selecting one piece of biometric information from said N pieces of biometric information acquired by said biometric information acquisition part, and for provisionally setting the selected biometric information as reference data to be used in biometric authentication;
an authentication test execution part for acquiring authentication-testing biometric information by causing said biometric information reader to read biometric information once, and for executing an authentication test by checking said authentication-testing biometric information against said reference data; and
a reference data optimization part for selecting one piece of biometric information from (N+1) pieces of biometric information including said N pieces of biometric information acquired by said biometric information acquisition part and said authentication-testing biometric information acquired by said authentication test execution part, thereby optimizing said reference data.

2. The computer readable medium according to claim 1, wherein
said reference data optimization part calculates the respective feature quantities of said (N+1) pieces of biometric information, selects biometric information having a feature quantity found at the closest position to the center in a distribution of said respective feature quantities of said (N+1) pieces of biometric information, and sets the selected biometric information as said reference data.

3. The computer readable medium according to claim 1, wherein
after selecting one piece of biometric information from said (N+1) pieces of biometric information and optimizing said reference data, said reference data optimization part selects one piece of biometric information as inappropriate data from said (N+1) pieces of biometric information, and deletes the selected biometric information corresponding to said inappropriate data from said (N+1) pieces of biometric information.

4. The computer readable medium according to claim 3, wherein
said reference data optimization part selects biometric information as inappropriate data that has a feature quantity found at the farthest position from the center in a distribution of said respective feature quantities of said (N+1) pieces of biometric information.

5. The computer readable medium according to claim 1, wherein
said authentication test execution part and said reference data optimization part repeatedly come into operation.

6. The computer readable medium according to claim 5, wherein
said authentication test execution part calculates a distance between the feature quantity of said authentication-testing biometric information acquired from said biometric information reader and the feature quantity of said reference data, and gives notification to perform said authentication test again when said distance is greater than a predetermined threshold value.

7. An image processing system comprising an image processing device with a biometric authentication function, and an information processing device for generating reference data to be used in biometric authentication in said image processing device and for registering said reference data in said image processing device, said image processing device and said information processing device being connected through a network,
said information processing device including:
a biometric information reader for reading biometric information;
a biometric information acquisition part for acquiring N pieces of biometric information by causing said biometric information reader to read biometric information N times (N is an integer of 3 or greater);
a reference data selection part for selecting one piece of biometric information from said N pieces of biometric information acquired by said biometric information acquisition part, and for provisionally setting the selected biometric information as reference data to be used in biometric authentication;
an authentication test execution part for acquiring authentication-testing biometric information by causing said biometric information reader to read biometric information once, and for executing an authentication test by checking said authentication-testing biometric information against said reference data;
a reference data optimization part for selecting one piece of biometric information from (N+1) pieces of biometric information including said N pieces of biometric information acquired by said biometric information acquisition part and said authentication-testing biometric information acquired by said authentication test execution part, thereby optimizing said reference data; and
a reference data transmission part for transmitting said reference data optimized by said reference data optimization part to said image processing device, and
said image processing device including:
a biometric information reader for reading biometric information;
a recording part for recording therein said reference data received from said information processing device; and
an authentication processor for performing biometric authentication by checking biometric information received from said biometric information reader of said image processing device against said reference data recorded in said recording part, and for enabling a function relating to image processing when biometric authentication ends in success.

8. An image processing device with a biometric information reader, said image processing device executing biometric authentication by comparing biometric information received from said biometric information reader and reference data registered therein in advance, and enabling a function relating to image processing when said biometric authentication ends in success, said image processing device comprising:
a biometric information acquisition part for acquiring N pieces of biometric information by causing said biometric information reader to read biometric information N times (N is an integer of 3 or greater);
a reference data selection part for selecting one piece of biometric information from said N pieces of biometric information acquired by said biometric information acquisition part, and for provisionally setting the selected biometric information as reference data to be used in biometric authentication;
an authentication test execution part for acquiring authentication-testing biometric information by causing said biometric information reader to read biometric information once, and for executing an authentication test by checking said authentication-testing biometric information against said reference data;
a reference data optimization part for selecting one piece of biometric information from (N+1) pieces of biometric information including said N pieces of biometric information acquired by said biometric information acquisition part and said authentication-testing biometric information acquired by said authentication test execution part, thereby optimizing said reference data; and
a reference data registering part for registering said reference data optimized by said reference data optimization part.

9. The image processing device according to claim 8, wherein
said reference data optimization part calculates the respective feature quantities of said (N+1) pieces of biometric information, selects biometric information having a feature quantity found at the closest position to the center in a distribution of said respective feature quantities of said (N+1) pieces of biometric information, and sets the selected biometric information as said reference data.

10. The image processing device according to claim 8, wherein
after selecting one piece of biometric information from said (N+1) pieces of biometric information and optimizing said reference data, said reference data optimization part selects one piece of biometric information as inappropriate data from said (N+1) pieces of biometric information, and deletes the selected biometric information corresponding to said inappropriate data from said (N+1) pieces of biometric information.

11. The image processing device according to claim 10, wherein
said reference data optimization part selects biometric information as inappropriate data that has a feature quantity found at the farthest position from the center in a distribution of said respective feature quantities of said (N+1) pieces of biometric information.

12. The image processing device according to claim 8, wherein
said authentication test execution part and said reference data optimization part repeatedly come into operation.

13. The image processing device according to claim 12, wherein
said authentication test execution part calculates a distance between the feature quantity of said authentication-testing biometric information acquired from said biometric information reader and the feature quantity of said reference data, and gives notification to perform an authentication test again when said distance is greater than a predetermined threshold value.
